(19) United States
(12) Patent Application Publication
(10) Pub. No.: US 2026/0091251 A1
(43) Pub. Date: Apr. 2, 2026

(54) Fall Arrest Device with Settable Cable Length and Rollable Shell

(71) Applicant: Latchways plc, Dorset (GB)

(72) Inventors: Victor LEJEUNE, Lytchett Matravers (GB); Owain JONES, Wiltshire (GB); Maria RODRIGUEZ, Lytchett Matravers (GB)

(21) Appl. No.: 19/112,648

(22) PCT Filed: Sep. 20, 2023
(86) PCT No.: PCT/EP2023/075886

§ 371 Date: Mar. 18, 2025

(30) Foreign Application Priority Data
Sep. 21, 2022 (GB) 2213761.6

(51) Int. Cl. A62B 35/00

(52) U.S. Cl. CPC A62B 35/0093; A62B 35/0081

(57) ABSTRACT

The invention relates to a safety device, the device comprises a fall arrest device, and a rollable, protective shell surrounding the fall arrest device, wherein the shell comprises a case; a first contact surface ring encompassing the case; and a second contact surface ring encompassing the case; wherein the first contact surface ring and the second contact surface ring each comprise multiple continuous curved surfaces; wherein the case, the first contact surface ring, and the second contact surface ring provide a first aperture for access to a first actuator of the fall arrest device.

### FIELD OF INVENTION

The present invention relates to a rollable, protective shell for fall arrest devices. In particular, the present invention provides a rollable shell for use with a self-retracting lifeline device having a mechanism for setting or restricting the maximum length of cable that can be paid out of the device.

### BACKGROUND

Fall arrest devices are used to prevent personnel from suffering injury as a result of falling from an elevated working location (e.g., roof). Fall arrest devices are often referred to as height safety systems or fall prevention systems. A device may include a so-called safety block arranged to be suspended from an anchor structure. Such arrangements may include a drum upon which a cable is wound, a speed responsive mechanism arranged to inhibit the drum rotation above a predetermined rotational speed, and an energy absorber device arranged to be activated if a load above a predetermined threshold is deployed when the speed responsive mechanism is deployed. The cable is then attached to a harness worn by a user.

### SUMMARY

In one aspect, the present disclosure provides a safety device, the device comprising:
a fall arrest device, and
a rollable, protective shell surrounding the fall arrest device, wherein the shell comprises:
   a case;
   a first contact surface ring encompassing the case; and
   a second contact surface ring encompassing the case;
   wherein the first contact surface ring and the second contact surface ring each comprise multiple continuous curved surfaces;
   wherein the case, the first contact surface ring, and the second contact surface ring provide a first aperture for access to a first actuator of the fall arrest device.

Advantageously, the safety device comprises an extendable cable configured to secure a user to the fall arrest device, wherein the cable is extendable to a maximum length that is adjustable by manipulation of the first actuator of the fall arrest device.

In any embodiment, the fall arrest device may comprise:
a drum configured to have a cable wound thereon;
a speed responsive engagement assembly arranged to inhibit rotation of the drum above a predetermined rotational speed; and
a traveller configured to move in response to rotation of the drum, wherein the traveller is configured to activate the speed responsive engagement assembly when a predetermined length of cable has been fed out; and
the first actuator.

In another aspect, the present disclosure provides a method of using the safety device, comprising:
attaching the case to an anchor point;
setting a maximum length of cable which the fall arrest device will pay out using the first actuator; and
attaching the case to a user,
wherein movement of the user results in rolling of the rollable, protective shell on the first and second contact surface rings on a rest surface.

In another aspect, the present disclosure provides a method of fabricating a safety device comprising:
providing a fall arrest device comprising a first actuator for setting a maximum length of cable which the fall arrest device will pay out;
providing a shell encasing the fall arrest device;
providing a first contact surface ring and a second contact surface ring wherein at least one of the first contact surface ring and the second contact surface ring comprises multiple continuous curved surfaces to the shell such that the shell, the first contact surface ring, and the second contact surface ring permit manipulation of the first actuator via a space between the contact surface rings;
wherein the contact surface rings are configured to prevent contact of the first actuator with a rest surface.

### BRIEF DESCRIPTION OF THE DRAWINGS

Illustrative embodiments of the fall arrest device will now be described in relation to the accompanying drawings, in which:

FIG. 1 shows an embodiment of a safety device comprising a fall arrest device encased within a rollable, protective shell;

FIG. 2 shows a second embodiment of a safety device comprising a fall arrest device encased within a rollable, protective shell;

FIG. 3 shows depicts a side view of the safety device shown in FIG. 2;

FIG. 4 shows one embodiment of a safety device in use by a user;

FIG. 5a shows a close up of the safety device shown in FIG. 4;

FIG. 5b shows an exemplary path along which the first and second surface contact rings may travel as the safety device rolls along a rest surface;

FIG. 6 shows an end-view of a safety device comprising a fall arrest device encased within a rollable, protective shell;

FIG. 7 is an exploded view of a settable length fall arrest device that may be encased in a rollable, protective shell as described herein; and

FIG. 8 shows a front view of the fall arrest device in FIG. 7 when assembled.

### DETAILED DESCRIPTION

As used herein, the singular form of “a,” “an,” and “the” include plural referents unless the context clearly dictates otherwise.

Unless otherwise indicated, all ranges or ratios disclosed herein are to be understood to encompass the beginning and ending values and all subranges or sub-ratios subsumed therein. For example, a stated range or ratio of “one to ten” should be considered to include any and all subranges or sub-ratios between (and inclusive of) the minimum value of one and the maximum value of ten; that is, all subranges or sub-ratios beginning with a minimum value of one or more and ending with a maximum value of ten or less. The ranges and/or ratios disclosed herein represent the average values over the specified range and/or ratio.

The terms “first,” “second,” and the like are not intended to refer to any particular order or chronology, but refer to different conditions, properties, or elements and merely serve to distinguish one element that is similarly named as another element.

All documents referred to herein are “incorporated by reference”in their entirety.

The term “arcuate” is used to mean curved. The curve may be an arc of a circle or an arc of any part of an elliptical.

The term “at least” is synonymous with “greater than or equal to.”

As used herein, “at least one of” is synonymous with “one or more of.” For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The word “comprising” and “comprises,” and the like, does not exclude the presence of elements or steps other than those listed in any claim or the specification as a whole. In the present specification, “comprises” means “includes” and “comprising” means “including.”

The disclosure comprises, consists of, or consists essentially of, the following embodiments or aspects, in any combination. Various embodiments or aspects of the disclosure are illustrated in separate drawing figures. However, it is to be understood that this is simply for ease of illustration and discussion. In the practice of the disclosure, one or more embodiments or aspects shown in one drawing figure can be combined with one or more embodiments or aspects shown in one or more of the other drawing figures. As used herein, “cable” and “lifeline” are used synonymously to refer to the line which attaches a user directly or indirectly to a fall arrest device as described herein.

Embodiments of systems and methods herein are related to fall arrest devices. A self-retracting lifeline (SRL) is one type of fall arrest device which includes a rewinding mechanism configured to automatically pay out and retract the cable as necessary to allow a user to move about the device whilst keeping the cable taut. The drum upon which the cable is wound is therefore biased to rewind the cable onto the drum.

Certain fall arrest devices, including self-retracting lifeline devices, may not prevent a user from falling. Rather, they may be designed to arrest the descent of the user's fall and attempt to limit any injuries sustained as a result of the fall. Any fall or fall arrest event is likely to result in some distress and trauma to the user, whether mental or physical. Thus, in addition to reducing injuries associated with a fall, it may be desirable to reduce the likelihood of the user falling at all while wearing the fall arrest device. One option for reducing the likelihood of a user falling (without making any changes to the worksite itself) is to restrict the length of the cable paid out from a fall arrest device so that the user cannot reach the very edge of the worksite. Limiting cable length may also reduce trip hazards for the user and other personnel in the area. Depending on details of the worksite (e.g., a distance from an anchor point to a drop off, the number of workers working near the worksite, equipment present at the worksite), the desired maximum cable pay out length may vary from one operational scenario to the next. Thus, fall arrest devices may be provided that enable configuration of maximum cable pay out lengths, such as via manipulation of controls in the form of dials or other mechanisms.

One example of a fall arrest device which allows the user to set the maximum length of the cable that can be paid out is described in U.S. Pat. No. 10,207,128 to Hetrich and assigned to MSA Technology, LLC of Cranberry Township, Pennsylvania, the entirety of which is herein incorporated by reference. There, the maximum length of cable that can be paid out is controlled by a plurality of gears and a pivot mechanism.

Fall arrest devices are generally either connected to an anchor point proximate foot (or surface) level or suspended from an anchor point above head height. In some situations, the device must be anchored at foot level (for example when working on a flat roof or the like). If the fall arrest device is anchored at floor level, the device can be dragged around on the floor (or other surface it is supported on) as the user moves around the site. This can damage the fall arrest device and the important safety labels attached to the outside shell of the device. If the shell, working mechanisms of the fall arrest device, and/or safety information is compromised, then the device may need to be replaced because it no longer functions as necessary to keep the user safe. This is costly and inconvenient. Certain embodiments herein may mitigate these harms and otherwise improve the performance of fall arrest devices.

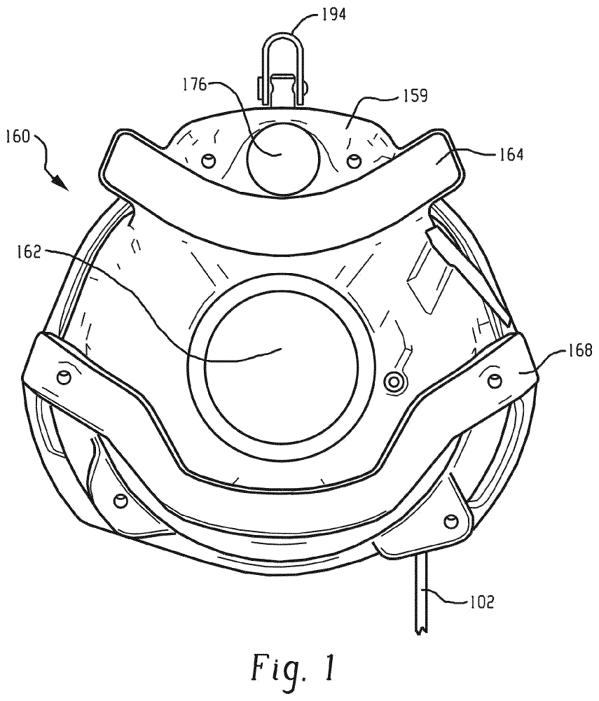

FIG. 1 shows a safety device comprising a fall arrest device encased within a rollable, protective shell 160, the shell 160 comprising a case 159, a first contact surface ring 164, and a second contact surface ring 168.

The fall arrest device (not visible through the case 159), which is encompassed within the case 159 comprises a drum around which a cable 102 is wound and which is paid out through an outlet (not visible from this angle) in the case 159. The fall arrest device may comprise one or more actuators (not shown) for adjusting various settings of the fall arrest device, such as the maximum amount of cable 102 that may be paid out.

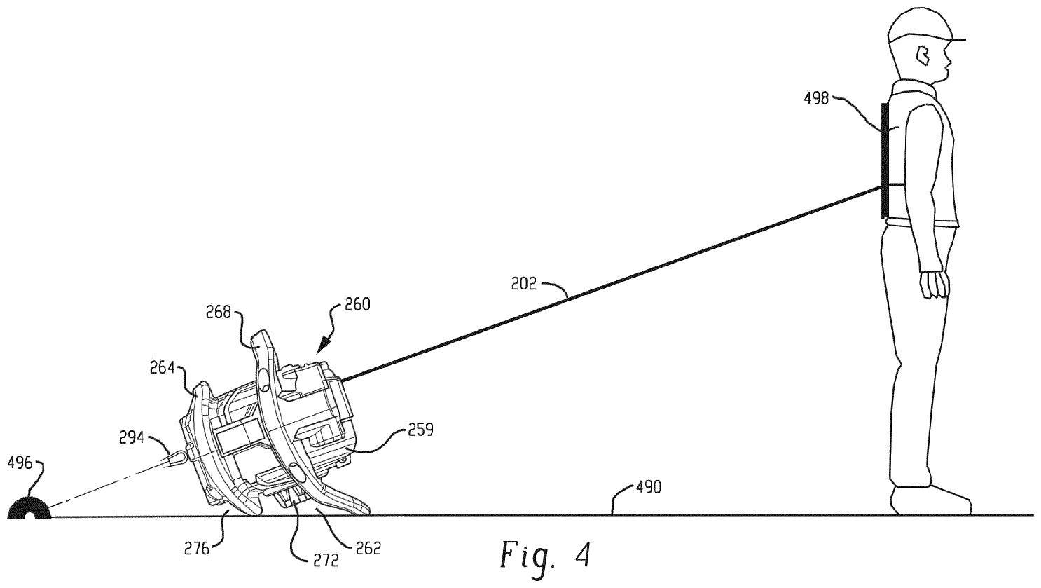

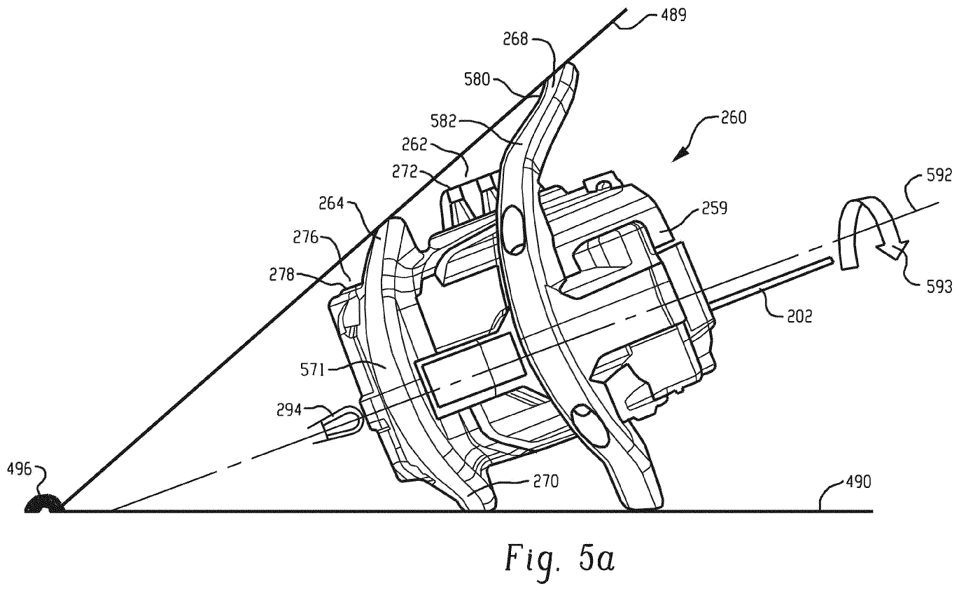

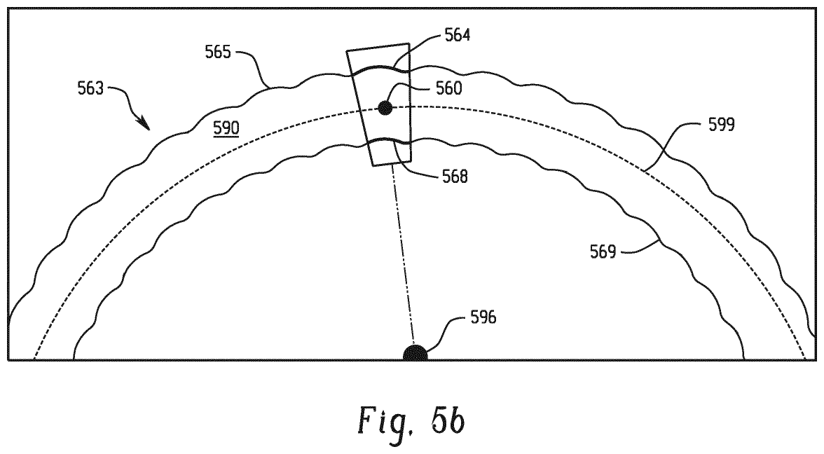

Contact surface rings 164, 168 allow the shell 160 to roll smoothly during use on a rest surface (e.g., a floor, a roof), which is the surface on which the shell 160 rests via the contact surfaces rings 164, 168. The ability of the shell to roll along with the shape of the path travelled by the contact surface rings during rolling will be discussed in further detail with respect to FIGS. 5a and 5b. In embodiments, the contact surface rings 164, 168 are the only portions of the shell 160 which contact the rest surface during proper operation. Each of the first and second contact surface rings 164, 168 may be integral to the case 159 or one or both may be reversibly attached to the case 159. The case 159 further comprises a connector 194 for securing the case 159 encompassing the fall arrest device to an anchor (not shown). In any embodiment, the connector 194 may be, for example, a shackle or eyelet. In any embodiment, the connector 194 may be bolted or otherwise attached to the case 159. The shell 159 further comprises a cable outlet (not shown) through which the cable 102 of the fall arrest device may extend. The case 159 (and shell 160) may roll about an axis (see, e.g., FIGS. 4 and 5a) that can be defined as extending from the end of the case 159 comprising the cable outlet (bottom of FIG. 1) to the opposite end of the case 159 comprising the connector 194 (top of FIG. 1).

The first contact surface ring 164, second contact surface ring 168, and case 159 of the rollable, protective shell 160 provide a first aperture 162 (e.g., an opening) through which an actuator (not shown) of the fall arrest device encased therein may be accessible to manipulation by a user. As such, neither of the first contact surface ring 164 nor the second contact surface ring 168 hinder the manipulation of the actuator. Optionally, the first contact surface ring 164 together with the case 159 of the shell 160 provide a second aperture 176 through which an optional second actuator (not shown) of the fall arrest device encased therein may be accessible to manipulation by a user.

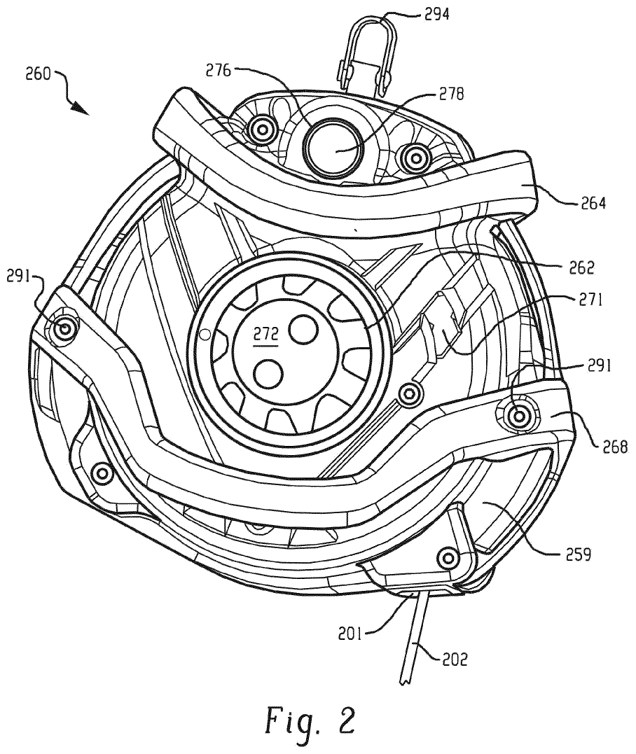

FIG. 2 depicts one embodiment of a safety device comprising a rollable, protective shell 260 comprising a case 259, a first contact surface ring 264 which is integral to the case 259, and a second contact surface ring 268 which is reversibly connected to the case 259 by mechanisms of attachment 291, which may be, for example, bolts or screws. The case 259 further comprises a connector 294 for securing the case 259 to an anchor (not shown). The case 259 further comprises a cable outlet 201 through which the cable 202 of the fall arrest device may extend.

In FIG. 2, the cable outlet 201 is positioned off-centre on the safety device 260, which, in combination with the tension imposed on the cable 202 by the safety device 260 and the user (not shown), causes the safety device 260 to rotate such that the cable 202 is in an elevated position relative to the rest surface on which the safety device sits. This will be described further with respect to FIG. 4.

The first contact surface ring 264, second contact surface ring 268, and case 259 of the rollable, protective shell 260 provide a first aperture 262 through which a first actuator 272 of the fall arrest device encased therein may be accessible to manipulation by a user. Optionally, the first contact surface ring 264 together with the case 259 of the shell 260 provide a second aperture 276 through which a second actuator 278 of the fall arrest device encased therein may be accessible to manipulation by a user.

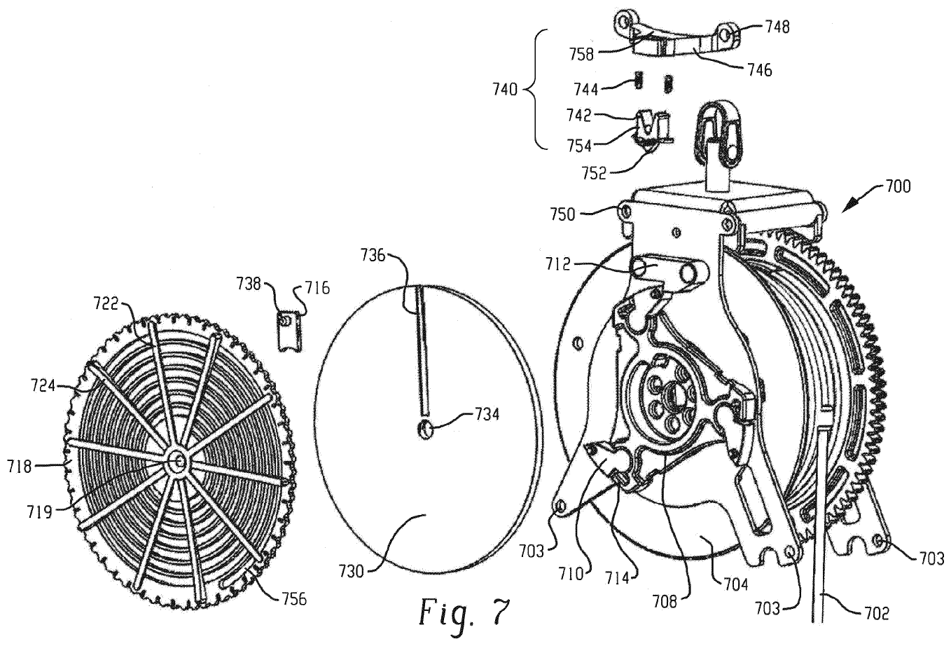

The first actuator 272 may be of any type suitable for adjusting any aspect of the function of the fall arrest device. For example, in some embodiments, the first actuator 272 is a dial to set the length of cable 202 that may be paid out from the fall arrest device. In some embodiments, the maximum length of cable 202 that may be paid out from the fall arrest device may be controlled via placement of a traveller within a traveller wheel, which will be discussed further below with respect to FIG. 7. The second actuator 278 may be of any type to adjust any aspect of the function of the fall arrest device. For example, in some embodiments, the second actuator 278 controls whether or not the cable 202 is able to be paid out or not. In some embodiments, this aspect may be controlled, for example, through engagement and disengagement of a stopper, which will be discussed further below with respect to FIG. 7.

Optionally, the case 259 may comprise a window 271 to display a setting of an actuator of the fall arrest device, e.g., the first actuator 272.

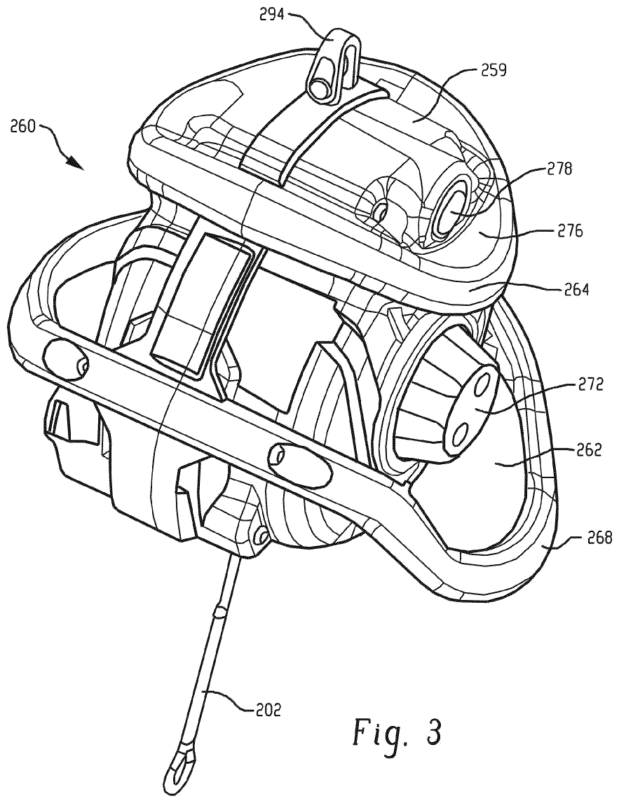

FIG. 3, where like numbers represent like elements as discussed for FIG. 2, depicts a side view of the safety device comprising a rollable, protective shell 260 comprising a case 259, first contact surface ring 264, and a second contact surface ring 268, each of which are configured and shaped to provide a first aperture 262 that allows access by a user to a first actuator 272. Optionally, the first contact surface ring 264 is configured and shaped to provide a second aperture 276 that allows access by a user to a second actuator 278. The case 259 encompassing the fall arrest device comprises a connector 294 for securing the case 259 (and fall arrest device therein) to an anchor (not shown). A cable 202 of the fall arrest device extends through a cable outlet (not visible from shown angle) on the case 259 and may be attached to a harness on a user (not shown).

FIG. 4, where like numbers represent like elements as discussed for FIGS. 2 and 3, depicts one embodiment of a safety device in use by a user 498. A fall arrest device is encased within a rollable, protective shell 260 comprising a case 259, a first contact surface ring 264, and second contact surface ring 268. The rollable protective shell 260 rests via the first contact surface ring 264 and second contact surface ring 268 on a contact surface 490. A connector 294 secures the case 259 encompassing the fall arrest device to an anchor 496 on the rest surface 490. The cable 202 of the fall arrest device extends through a cable outlet (not visible from shown angle) on the case 259 and is attached to a point on a user 498, for example, a harness. As described above with respect to FIG. 2, the cable outlet (not visible) is positioned off-centre on the safety device 260, which, in combination with the tension imposed on the cable 202 by the safety device 260 and the user 498, causes the safety device 260 to rotate such that the cable 202 is in an elevated position relative to the rest surface 490, thereby preventing the cable 202 from contacting and potentially becoming damaged by the rest surface 490 or any objects also resting thereon. It should be noted that while the anchor 496 is depicted in FIG. 4 as being on the same rest surface 490 on which the user 498 stands, the anchor 496 may be at any location relative to the user 498, for example, in an elevated position. It is important to also note that the figures are schematic illustrations which are not drawn to scale.

In use, when the user 498 moves around the rest surface 490, rollable, protective shell 260 can roll smoothly on the first and second surface contact surface rings 264, 268 about the structural anchor 496. This prevents the case 259 from scraping along the rest surface 490 and becoming damaged. Additionally, first and second contact surface rings 264, 268 are configured and sized sufficiently to prevent contact of the first actuator 272 with the rest surface 490, thereby preventing damage of the first actuator 272. Additionally, first and second contact surface rings 264, 268 are configured and shaped to provide a first aperture 262 and optionally, a second aperture 276, to allow a user access to manipulate the first actuator 272 and, optionally, second actuator 278.

FIG. 5a depicts a close-up view of the safety device of FIG. 4, where like numbers represent like elements. The case 259 encompassing the fall arrest device is able to rotate about a rotational axis 592 (dashed line, see arrow) orientated in the same direction as the cable 202. This is advantageous as it ensures that the cable 202 does not get tangled as the case 259 encompassing the fall arrest device rolls upon the first contact surface ring 264 and second contact surface ring 268 of the rollable, protective shell 260. The rotational axis 592 is inclined relative to the rest surface 490. The first contact surface ring 264 and the second contact surface ring 268 each comprise multiple continuous curved surfaces. In some embodiments, such as that shown in FIG. 5a, the multiple continuous curved surfaces of at least one of the first contact surface ring 264 and the second contact surface ring 268 comprise at least one convex portion and at least one concave portion. For example, the second contact surface ring 268 of FIG. 5a comprises a convex portion 580 and concave portion 582. Similarly, the first contact surface ring 264 of FIG. 5a comprises a convex portion 570 and concave portion 571. However, despite the non-circular, irregular shape of each of the first and second contact surface rings 264, 268, the shape of the rollable protective shell, which includes the case 259 and first and second contact rings 264, 268, is generally conical or frustoconically shaped as shown in FIG. 5a by bold lines 489 and 490 (which also represents the rest surface) and rolls smoothly as a cone would along the rest surface as shown by arrow 593.

The safety device rolls on a single arcuate path on a rest surface, however, the path of one or more of the first and second contact surface rings may not follow a single arcuate path. For example, FIG. 5b depicts an arcuate path 599 on a rest surface 590 that may be travelled by safety device comprising a fall arrest device encased in a rollable, protective shell in the aggregate (e.g., the path a central point 560 (e.g., a centre of mass, a centroid, other centrally located point) of the device traverses. FIG. 5b further depicts paths 565, 569 that the first contact surface ring 564 and a second contact surface ring travel, respectively relative to the rest surface 590. Each path 565, 569 is defined by the contact location of each of the first contact surface ring 564 and second contact surface ring 568, respectively, on the rest surface 590. Collectively, the device traverses an arcuate path 599 around the anchor 596, the arcuate path defined by the rolling of the frustro(conical) shaped shell. However, each of the first contact surface ring path 565 and the second surface ring contact path 569 each may comprise multiple discontinuous arcuate portions (e.g., not a single smooth arc), the particular shape and size of which that are defined by the size and shape of the surface contact rings 264, 268.

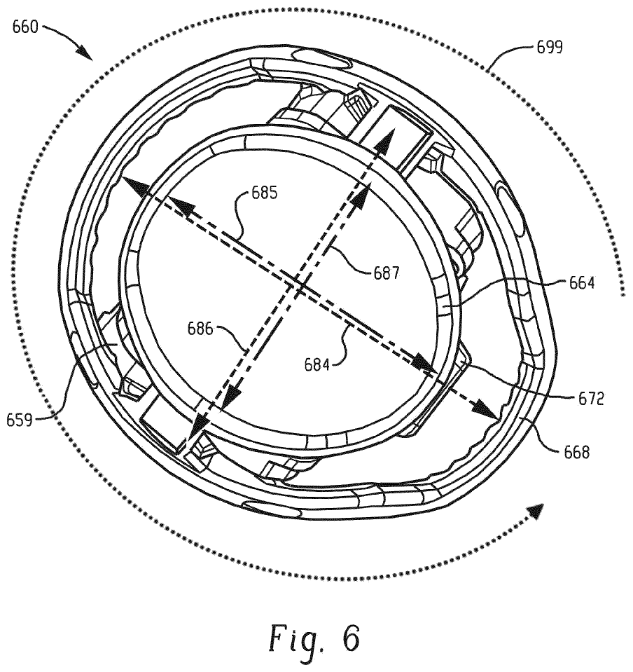

FIG. 6 depicts an end view of the safety device in FIG. 5a. The safety device comprises a rollable, protective shell 660 comprising fall arrest device (not visible through case 659), a case 659, a first surface contact surface ring 664, and a second surface contact ring 668. A curved dotted line 699 how the rollable protective shell, which is conical or frustoconical shaped, may roll about a rotational axis during use. The radius or radii of curved dotted line 699 is determined by the relative frustoconical cross-sectional dimensions of the contact surface rings 664, 668. For example, the second contact surface ring 668 may be substantially elliptical in shape and be characterized by a major diameter 684 (dashed line) and a minor diameter 686 (dashed line). The first contact surface ring 664 may also be characterized by a first major diameter 685 (dot-dashed line) and a first minor diameter 687 (dot-dashed line). The dimensions of the first and second contact surface rings 664, 668 also prevent the first actuator 672 from contacting the rest surface. The shape of the first and second contact surface rings 664, 668 also inhibits rolling of the shell 660 along any other rotational axes.

FIG. 7 is an exploded view of one embodiment of a settable length fall arrest device 700 that may be encased by a rollable, protective shell comprising a case, first contact surface ring, and second contact surface ring, as disclosed herein. The fall arrest device 700 may be secured to one or more interior surfaces of a case by any attachment mechanism, such as bolts, screws, glue, or the like. For example, in FIG. 7, screws (or the like) may be used to reversibly attach securing apertures 703 on the fall arrest device 700 to similar apertures on the case.

The fall arrest device 700 shown is a self-retracting lifeline device of the type described in U.S. Pat. No. 10,653,903 to Jones et al. and assigned to Latchways Plc. of Devizes, UK. However, it will be appreciated that other types of fall arrest devices could be used together with a rollable, protective shell of the present disclosure.

The fall arrest device 700 includes a rotatable drum 704 with a cable 702 wound thereon. The drum 704 is mounted to a rotatable shaft (not shown). The drum 704 is biased by a rewind mechanism (not shown) to rewind the cable 702 onto the drum 704, thus it is a self-retracting lifeline device. A speed responsive engagement assembly is provided which includes a pawl carrier 708, pawls 710, and a pawl stop formation 712. In the embodiment shown in FIG. 7, the speed responsive engagement assembly is as described in U.S. Pat. No. 10,653,903. However, it will be appreciated that other speed responsive engagement assemblies could be provided, such as those described in detail in U.S. Pat. No. 9,132,301 to Jones et al. and assigned to Latchways Plc. of Devizes, UK.

In some embodiments, three spaced pawls 710 are pivotally mounted to the pawl carrier 708. In some embodiments or aspects, two pawls or four or more pawls may be provided. A biasing spring 714 urges each pawl 710 radially inwards toward the pawl carrier 708 into a home position, such that the pawls 710 do not engage the pawl stop formation 712. In normal use, the cable 702 is paid out from the device 700 causing the drum 704, shaft, and pawl carrier 708 to rotate together. In a fall arrest event, the cable 702 is paid out much more rapidly. The speed at which the drum 704, shaft, and pawl carrier 708 rotate causes the pawls 710 to pivot radially outwards to an activated position, as the centrifugal force overcomes the biasing force of the springs 714. This causes one of the pawls 710 to engage the pawl stop formation 712 which is attached to or formed integrally with the chassis frame of the device 700. Once this occurs, the pawl carrier 708 is locked against and fixed with respect to the chassis frame of the device, preventing further rotation of the pawl carrier 708 together with the drum 704 and shaft.

If the torque applied by the fall arrest event is sufficient, the drum 704 and shaft will continue rotation. This can result in further cable 702 being paid out and the continued descent of a user. In this case, the energy absorber ring (not shown) will absorb the energy of the relative rotation between the pawl carrier 708 and the collar of the shaft until the fall is completely

It will be appreciated that in some non-limiting embodiments or aspects, an external energy absorber device may be provided rather than an internal energy absorber ring. The external energy absorber device is usually connected between the cable 702 and the user. Examples of suitable devices are described UK U.S. Pat. No. 2,572,019 to Jones et al. and assigned to Latchways Plc. of Devizes, UK.

In FIG. 7, the settable length fall arrest device of the present disclosure includes a stop assembly 740, a carrier plate 730, a traveller 716, and a traveller plate 718. The fall arrest device is configured to be mounted to the pawl carrier 708. Advantageously, the fall arrest device (i.e., the carrier plate 730, traveller 716 and traveller plate 718) can be attached to an existing fall arrest device 700, as an add-on or bolt-on.

The traveller plate 718 includes a plurality of radial spokes 720 mounted to the front of the traveller plate 718. The spokes 720 are evenly spaced around the traveller plate 718. In this embodiment or aspect, the traveller plate 718 includes five locking spokes 722 and five non-locking spokes 724. As shown in FIG. 7, the locking spokes 722 have a raised profile which is configured to abut the point 752 of the stopper 742, thereby preventing the traveller plate 718 from rotating. The non-locking spokes 724 have a flat profile and are configured to pass underneath the stopper 742 without engaging the point 752. It will be appreciated that, in some non-limiting embodiments or aspects, a different number of locking spokes 722 may be provided and/or the non-locking spokes 724 may not be provided.

The traveller plate 718 includes a central aperture 719 for receiving a bolt therethrough. A single bolt (not shown) may be inserted through apertures 719 and 734 in order to mount the traveller plate 718 and the carrier plate 730 to the pawl carrier 708.

A helical path 756 extends from proximate the central aperture 719 radially outwards towards the circumference of the traveller plate 718, between a start point 126 and an end point 128 of the path. The number of turns of the helical path 756 are not limited to the embodiment or aspect shown in FIGS. 1 and 2. In some non-limiting embodiments or aspects, the helical path 756 may be a curved path (e.g., including one or fewer turns).

In some embodiments, the carrier plate 730 includes a central aperture 734 for receiving a bolt therethrough. The back of the carrier plate (not shown) may be keyed to the pawl carrier 708. The carrier plate 730 is configured to be mounted to and rotate with the pawl carrier 708.

The carrier plate 730 includes a guide 736 extending from the circumference of the carrier plate 730 towards the central aperture 734. The guide 736 extends transversely to the rotational axis of the drum 704.

In FIG. 7, the guide 736 is a radial channel. In some non-limiting embodiments or aspects, the guide 736 may additionally or alternatively include one or more runners or guide rails. The traveller 716 may be mounted to slide along a rail or runner of the guide 736. The traveller 716 includes a projection or protrusion 738. In use, the traveller 716 is sandwiched between the carrier plate 730 and a traveller plate 718 in such a manner that the traveller is able to “ride” within the helical path 756 (of traveller plate 718). The start position of the traveller protrusion 738 along the helical path 756 dictates the length of cable 702 that can be paid out from the fall arrest device 700. As the cable 702 is paid out of the device the carrier plate 730 rotates relative to the traveller plate 718 which is held in a fixed position by the stopper 742. This causes the projection 738 of the traveller 716 to move along the helical path 756 of the traveller plate 718 and simultaneously, the traveller 716 sliding radially outwards along the radial channel 736 in the carrier plate 730.

In some embodiments, a stop assembly 740 is provided including a stopper 742, biasing members 744, and a stopper base 746. The stopper base 746 includes a pair of mounting apertures 748 arranged to align with apertures 750 on the chassis frame of the fall arrest device. The stopper 742 is shaped generally V-shaped, having a point 752 and a pair of legs 754. It will be appreciated that the stopper 742 is not limited to the shape shown in FIG. 7.

In some embodiments, the stopper 742 is moveable between an engaged position, in which the stopper 742 holds the traveller plate 718 in a fixed position, and a disengaged position, in which the traveller plate 718 is free to rotate. An actuator (such as a latch or button) configured to move the stopper 742 may be provided on the housing of the fall arrest device (not shown). The biasing members 744 bias the stopper 742 towards the engaged position.

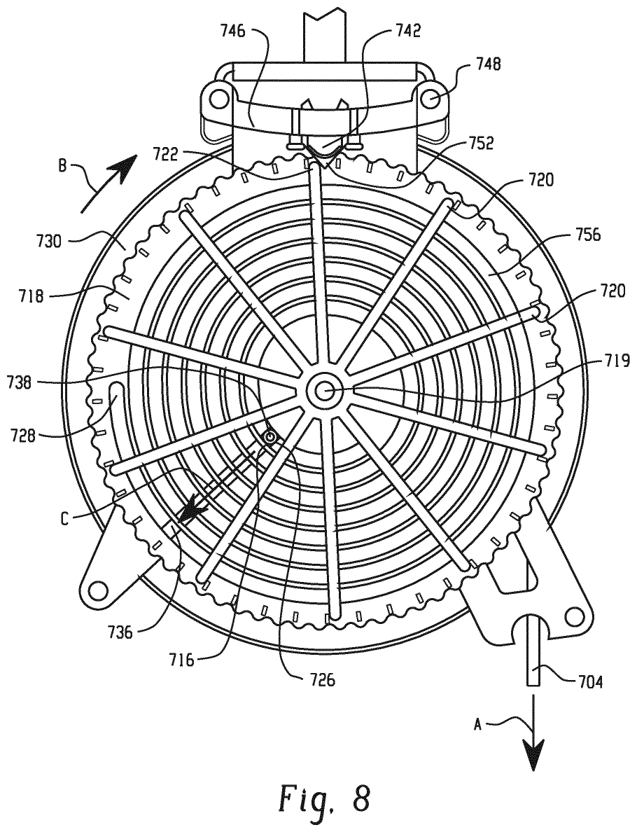

FIG. 8, where like numbers represent like elements as discussed for FIG. 7, is a front view of the fall arrest device 700 in FIG. 7 when assembled. The traveller plate 718 is mounted to the carrier plate 730 about the carrier central aperture (not visible) and traveller central aperture 719. The stopper 742 is in the engaged position. One of the locking spokes 722 abuts the point 752 of the stopper 742, preventing the traveller plate 718 from rotating with the pawl carrier 708. The projection 738 of the traveller 716 is positioned towards the start point 726 of the helical path 756.

As the cable 702 is paid out of the device in direction A (under normal conditions, not in a fall arrest event), the drum 704, pawl carrier 708 and carrier plate 730 rotate together in direction B relative to the traveller plate 718 which is held in a fixed position by the stopper 742. This causes the projection 738 of the traveller 716 to move along the helical path 756 of the traveller plate 718 in the direction of arrow B (in this case in a clockwise direction). This results in the traveller 716 sliding radially outwards along the radial channel 736 in the carrier plate 730 in the linear direction shown by arrow C in FIG. 8.

Under normal conditions, the traveller 716 will move linearly radially outwards along the radial channel 756 until a pawl 710 of the speed responsive engagement assembly is received in a slot (not visible from shown angle) on the back of the traveller 716 and the pawl 710 is pushed into engagement with the pawl stop formation 712. This locks the pawl carrier 708 and prevents further cable 702 being paid out, as described above. Thus, the closer the initial position of the traveller 716 is to the start point 726 of the helical path 756 in the traveller plate 718, the more cable 702 can be paid out before the speed responsive engagement assembly locks the device 700. For example, the start position of the traveller 716 can be set to ensure that the user is restrained from the edge of a worksite, as the maximum amount of cable 702 that can be paid out before the traveller 716 engages the pawl 710 is less than the distance to the edge of the worksite.

If a fall arrest event occurs before the traveller 716 reaches the position where the pawl 710 is pulled (or pushed) into engagement with the pawl stop formation 712, the speed responsive engagement mechanism engages as it would absent the elements that allow the cable length of the fall arrest device to be set.

If the force in direction A pulling (or tensioning) the cable 702 is removed before the traveller 716 engages the pawl 710, then the drum 704 will rotate in the direction opposite to arrow B (anticlockwise) to retract the cable 702 onto the drum 704. The traveller plate 718 remains held in the fixed position relative to the carrier plate 730. This will cause the traveller 716 to travel back along the helical path 756 towards the start position 726, resulting in the traveller 716 sliding radially inwards along channel 756 in the opposite direction to arrow C.

Advantageously, the carrier plate 730, traveller plate 718, traveller 716, and stop assembly 740 are not load bearing, even in a fall arrest event. As such, they can be made of plastic which is cost effective and lightweight.

In FIG. 7 and FIG. 8 the traveller 716 is configured to move outwards (or radially outwards) in response to rotation of the drum 704 to pay out cable 702. However, in some non-limiting embodiments or aspects, the traveller 716 may be configured to move inwards in response to rotation of the drum 704 to pay out cable 702.

It will also be appreciated that the traveller 716 may be any type of actuator configured to move in response to rotation of the drum 704 and to activate the speed responsive engagement assembly when a predetermined length of cable 702 has been paid out. The traveller plate and carrier plate need not be provided.

Aspects of the fall arrest device and rollable, protective shell disclosed herein have been described by way of example only and it will be appreciated to the skilled addressee that modifications and variations may be made without departing from the scope of protection afforded by the appended claims. Please amend the claims as follows:

1. A safety device, the device comprising:
a fall arrest device, and
a rollable, protective shell surrounding the fall arrest device, wherein the shell comprises:
a case;
a first contact surface ring encompassing the case; and
a second contact surface ring encompassing the case;
wherein the first contact surface ring and/or the second contact surface ring each comprise multiple continuous curved surfaces;
wherein the case and the first contact surface ring and/or the second contact surface ring provide a first aperture for access to a first actuator of the fall arrest device.

2. The safety device of claim 1, further comprising an extendable cable configured to secure a user to the fall arrest device, wherein the cable is extendable to a maximum length that is optionally adjustable by manipulation of the first actuator of the fall arrest device.

3. The safety device of claim 1, wherein the first contact surface ring and the case further provide a second aperture for access to a second actuator of the fall arrest device.

4. The safety device of claim 3, wherein the second actuator is a stopping actuator to enable and/or disable the feed of the cable of the fall arrest device.

5. The safety device of claim 1, wherein the multiple continuous curved surfaces comprise at least one convex portion and at least one concave portion and/or have direction components extending into at least one direction perpendicular to a main plane of the respective contact surface ring and/or parallel to a rotational axis of the protective shell.

6. The safety device of claim 1, wherein at least one of the first contact surface ring has two first ring diameters and the second contact surface ring has two second ring diameters.

7. The safety device of claim 6, wherein the first contact surface ring has at least one first ring diameter which is different than at least one of the second ring diameters.

8. The safety device of claim 1, wherein the first and/or second contact surface rings are arranged and configured to contact a rest surface, optionally in order to enable rolling of the shell about the rotational axis.

9. The safety device of claim 8, wherein the rollable protective shell rolls on a single arcuate path, wherein optionally at least one of the first and second contact surface rings rolls on a path that comprises discontinuous multiple arcuate portions.

10. The safety device of claim 8, wherein the rotational axis is inclined at an angle relative to a res surface.

11. The safety device of claim 1, wherein the first and/or second contact surface rings are arranged and/or configured to allow a user access to the first aperture.

12. The safety device of claim 1, wherein the first and/or second contact surface rings are arranged and/or configured to prevent contact of the actuator of the fall arrest device with the rest surface during rolling.

13. The safety device of claim 1, wherein the case is conically or frustoconically shaped.

14. The safety device of claim 1, where at least one of the first and second contact surface rings is integral to the case.

15. The safety device of claim 1, wherein at least one of the contact surface rings is reversibly attached to the case.

16. The safety device of claim 1, wherein the case further comprises a connection point for receiving a connector, optionally for connecting the case to an anchor.

17. The safety device of claim 2, wherein the fall arrest device comprises:
a drum configured to have a cable wound thereon;
a speed responsive engagement assembly arranged to inhibit rotation of the drum above a predetermined rotational speed; and
a traveller configured to move in response to rotation of the drum, wherein optionally the traveller is configured to activate the speed responsive engagement assembly, optionally when a predetermined length of cable has been fed out; and
the first actuator.

18. The safety device of claim 17, wherein the traveller of the fall arrest device is moveable between a start position and an end position, wherein optionally the end position is arranged such that the traveller engages a component of the speed responsive engagement assembly.

19. The safety device of claim 18, wherein the start position of the traveller of the fall arrest device can be adjusted, optionally via the first actuator to set the predetermined length of cable.

20. The safety device of claim 19, wherein feed of the cable of the fall arrest device is disabled when a stopper is engaged with the traveler plate and/or enabled when the stopper is disengaged with the traveller plate, wherein optionally engagement of the stopper with the traveller plate is controlled by the second actuator.

21. The safety device of claim 1, wherein the fall arrest device is a self-retracting lifeline (SRL) device.

22. A method of using the safety device of claim 1, comprising:
attaching the case to an anchor point;
setting a maximum length of cable which the fall arrest device will pay out using the first actuator; and
attaching the case to a user,
wherein movement of the user results in rolling of the rollable, protective shell on the first and/or second contact surface rings on a rest surface.

23. A method of fabricating a safety device comprising:
providing a fall arrest device comprising a first actuator for setting a maximum length of cable which the fall arrest device will pay out;
providing a shell encasing the fall arrest device;
providing a first contact surface ring and a second contact surface ring wherein at least one of the first contact surface ring and the second contact surface ring comprises multiple continuous curved surfaces to the shell such that the shell, and the first contact surface ring and/or the second contact surface ring permit manipulation of the first actuator via a space between the contact surface rings;
wherein the contact surface rings are configured to prevent contact of the first actuator with a rest surface.
